(19) United States
(12) Patent Application Publication
(10) Pub. No.: US 2022/0022724 A1
(43) Pub. Date: Jan. 27, 2022

(54) SYSTEM HAVING A WATER-BEARING DOMESTIC APPLIANCE AND METHOD FOR OPERATING A WATER-BEARING DOMESTIC APPLIANCE

(71) Applicant: BSH Hausgeräte GmbH, Munich (DE)

(72) Inventors: Daniel Miller, Finningen (DE); Kai Paintner, Welden (DE); Alexander Rommel, Bächingen (DE); Katharina Scheck, Dillingen (DE); Helena Riehl, München (DE); Manuel Meyer, München (DE); Matthias Heckes, München (DE); Matthias Hüdig, Augsburg (DE)

(21) Appl. No.: 17/299,807

(22) PCT Filed: Sep. 30, 2019
(86) PCT No.: PCT/EP2019/076373

§ 371 Date: Jun. 4, 2021

(51) Int. Cl. A47L 15/42; A47L 15/46; G10L 15/22

(52) U.S. Cl. CPC A47L 15/4293; A47L 15/46; A47L 2301/04; G10L 2015/225; G10L 2015/223; G10L 15/22

(57) ABSTRACT

A system includes water-bearing household appliance which includes a controller apparatus for executing a treatment program from a plurality of treatment programs, with each of the treatment programs being defined by program parameters. A memory device stores treatment programs in the form of a N-dimensional matrix, with the treatment programs being associated with matrix elements of the matrix respectively. Each matrix element is determinable by a respective one of defined N-dimensional input vectors. An input captures a user input to change a program parameter, and a selection unit selects one of the defined N-dimensional input vectors as a function of the captured user input, with a determining unit determining a matrix element from the matrix as a function of the selected input vector. The controller apparatus carries out the treatment program associated with the determined matrix element.

The present invention relates to a system having a water-bearing household appliance, such as for example a household dishwasher, and to a method for operating a water-bearing household appliance.

Conventional water-bearing household appliances, such as for example dishwashers, have various automatic functions which are intended to make it easier for a user to operate the dishwasher. These include for example an automatic programming facility which is designed to optimize a cleaning result as a function of various factors, such as for example a soiling load in a washing liquor, certain presettings made by the user and the like.

In this connection, the document DE 196 51 346 A1 discloses a dishwasher with a control device, in which a full adjustment of the program sequence to a wide range of degrees of soiling of the dishes to be cleaned is enabled. Here, the program sequence can be preselected at the control device by means of at least one essentially steplessly adjustable parameter which is required for and is influenced by the wash cycle.

Against this background, an object of the present invention consists in further improving the operation of a household dishwasher.

According to a first aspect, a system is proposed with a water-bearing household appliance, in particular dishwasher, with a controller apparatus for carrying out one treatment program from a plurality M of treatment programs, wherein each of the treatment programs is defined by a number of program parameters, a memory device for storing the M treatment programs in the form of an N-dimensional matrix, wherein one of the M treatment programs is associated in each case with a matrix element of the matrix, wherein the respective matrix element can be determined by means of one of a plurality of defined N-dimensional input vectors, an input means for capturing a user input to change at least one of the program parameters, a selection unit for selecting one of the defined N-dimensional input vectors as a function of the captured user input, a determining unit for determining one matrix element from the matrix by means of the selected input vector, wherein the controller apparatus is configured to carry out the treatment program associated with the determined matrix element.

Here, the process technology available in the water-bearing household appliance is used optimally, taking into consideration the individual preferences of the user. In this context, the user can change at least one of the program parameters which determine the treatment program to be selected by means of his/her user input. The program parameters comprise for example a cleaning intensity, a drying intensity and a program duration. A certain input vector is selected from the possible input vectors as a function of the captured user input to change the program parameters. By means of the selected input vector, the matrix element associated with the selected input vector is then in turn determined from the matrix for storing the treatment programs. By means of the determined matrix element, a certain one of the possible treatment programs is identified and thus determined. This determined treatment program can then be carried out by the controller apparatus. The assignment of the treatment programs to the matrix elements of the matrix takes place as a function of the program parameters used to map the user's wish according to the user input and is thus selected particularly expediently. If the user wishes for example to increase the cleaning intensity, then the matrix element which follows the current matrix element in the matrix has an increased cleaning intensity. If one considers one of the program parameters, for example the cleaning intensity, then the matrix elements in this dimension of the matrix are arranged in ascending order according to their intensity. The same preferably applies accordingly to the other program parameters.

The controller apparatus can be implemented in a hardware-based and/or also software-based manner. The controller apparatus is in particular integrated into the household appliance. Alternatively, the controller apparatus can also be arranged outside the household appliance. If implemented in a hardware-based manner, the controller apparatus can be embodied for example as a computer or as a microprocessor.

If implemented in a software-based manner, the controller apparatus can be embodied as a computer program product, as a function, as a routine, as part of a program code or as an executable object.

For example, the treatment program can comprise a washing program for washing items to be washed and/or a cleaning program for cleaning parts of the household appliance, for example a filter.

The controller apparatus is configured to carry out one washing program from a number of washing programs for washing the items to be washed. A washing program comprises for example different program sub-steps, such as a pre-rinse, a cleaning, a rinsing and/or a drying. Different washing programs differ for example with regard to a sequence and/or type of program sub-steps and with regard to different operating parameters, such as for example a duration and/or washing liquor temperature of one or several program sub-steps.

Items to be washed are arranged in the washing compartment, in particular on one or several receptacles for items to be washed, for washing with the household dishwasher. The items to be washed comprise in particular various dishes, items of cutlery and/or tools which are used for preparing, storing and/or consuming foods. These are for example plates, pots, cups, knives, glasses and the like.

According to one embodiment, the program parameters which can be adjusted by the user comprise a cleaning intensity, a drying intensity and/or a program duration. Via the input means, the user can set the cleaning intensity, the drying intensity and the program duration. As a function of this setting, a certain input vector of the N input vectors is selected, a corresponding matrix element is determined, and the treatment program associated with the matrix element is carried out.

According to a further embodiment, the number of adjustable program parameters is N, wherein the N-dimensional input vector has N vector components. Here, the respective vector component of the input vector relates to one of the N-dimensions of the matrix. If, as in the example above, there are three program parameters, the cleaning intensity, the drying intensity and the program duration, then the respective input vector also has three vector components.

According to a further embodiment, the matrix is a three-dimensional (xxyxz) matrix, where N=3. Here, x, y and z are discrete values and the number M of treatment programs corresponds to a product of x, y and z. If for example there are four possible settings for each of the program parameters, then M=4*4*4=64 different treatment programs and thus 64 different input vectors which can be selected.

According to a further embodiment, x defines a value range of a first vector component of the input vector, y defines a value range of a second vector component of the input vector, and z defines a value range of a third vector component of the input vector.

According to a further embodiment, the controller apparatus is configured, in response to a user input captured by the input means to change one of the program parameters outside the defined value range, to determine a measure and to trigger the execution of the determined measure. If for example the value range for the cleaning intensity is [1, 2, 3, 4] and the user specifies the value 5 for the cleaning intensity via a voice input, then his/her user input lies outside the defined value range of [1, 2, 3, 4]. A measure which the controller apparatus can then execute can be to display tips or advice to the user as to how the desired result can be improved by his/her intervention. Such advice can comprise maintenance advice, loading advice and operating advice. Examples of maintenance advice are filter cleaning, spray arm cleaning, replacing a cleaning agent type and the like. Loading advice comprises advice on where to place the respective dishes, particularly in which receptacle for items to be washed a particular type of dish should be placed. The loading advice can also comprise advice on drying, for example that vessels should be set slightly at an angle. Furthermore, the advice can comprise an explanation of the correlation between cleaning performance and drying performance and time required. Furthermore, advice can be given with regard to a remote start, for example via a smartphone, or timer programming. Should a further negative item of feedback from the user be detected, then the examination of the appliance by a customer service can be recommended.

According to a further embodiment, the input means has N haptic input devices. Here, each of the N haptic input devices is associated with one of the N adjustable program parameters.

According to a further embodiment, the respective haptic input device has a rotary dial, a rotary control or a slide control.

According to a further embodiment, the input means is configured to capture an item of feedback of the user after completion of one of the treatment programs and to change at least one of the program parameters as a function of the captured feedback.

According to a further embodiment, the input means comprises a voice dialog system, which is configured to capture the user's feedback in the form of voice inputs as the user's responses to voice outputs generated as questions by the voice dialog system. For example, the user can be asked via the voice dialog system: “Do you want to increase the cleaning intensity?” The appropriate input vector can be selected as a function of the user's response.

According to a further embodiment, the input means comprises a touch-sensitive display, which is configured to capture the user's feedback in the form of display inputs as the user's responses to questions output by the display. For example, the user can also be asked via the touch-sensitive display whether he/she would like to increase the cleaning intensity. Furthermore, the user can also be provided with two input fields via the touch-sensitive display, one input field with “Yes” and one input field with “No”. If the user then actuates the input field “Yes”, the value for the cleaning intensity is incremented for the selection of the input vector. If, however, the user selects the input field “No”, then no incrementation is performed.

According to a further example, the user can be asked via the touch-sensitive display whether he/she is satisfied with the drying of the items to be washed. If the user then actuates the input field “No”, the value for the drying intensity is incremented for the selection of the input vector. If, however, the user selects the input field “Yes”, then no incrementation is performed.

According to a further embodiment, the input means can be integrated in the household appliance. For example, the input means can be embodied as a touch-sensitive display or as a number of rotary controls and be arranged on the outside of the door.

According to a further embodiment, the input means is embodied as an app which can be installed on an external device. The external device is in particular a mobile device. The mobile device is for example a smartphone, a tablet or a tablet computer. The app can also be referred to as application, application software or application program. The app can be embodied in particular as a program, as a computer program, as software, as a computer program product, as a function, as a routine, as part of a program code or as an executable object.

The household appliance comprises in particular a communication unit, which can be connected for example by means of a network to the external device and thus to the app installed on the external device. Here, the network comprises in particular a mobile radio network, a WLAN and/or a further wireless or wired data network.

According to a second aspect, a water-bearing household appliance, in particular dishwasher, is proposed, which has a controller apparatus for carrying out one treatment program from a plurality M of treatment programs, wherein each of the treatment programs is defined by a number of program parameters, a memory device for storing the M treatment programs in the form of an N-dimensional matrix, wherein one of the M treatment programs is associated in each case with a matrix element of the matrix, wherein the respective matrix element can be determined by means of one of a plurality of defined N-dimensional input vectors, an input means for capturing a user input to change at least one of the program parameters, a selection unit for selecting one of the defined N-dimensional input vectors as a function of the captured user input, and a determining unit for determining one matrix element from the matrix by means of the selected input vector. Here, the controller apparatus is configured to carry out the treatment program associated with the determined matrix element.

According to a third aspect, a method for operating a water-bearing household appliance, in particular dishwasher, is proposed, with a controller apparatus for carrying out one treatment program from a plurality M of treatment programs, wherein each of the treatment programs is defined by a number of program parameters. The method comprises the following steps:
storing the M treatment programs in the form of an N-dimensional matrix in a memory device, wherein one of the M treatment programs is associated in each case with a matrix element of the matrix, wherein the respective matrix element can be determined by means of one of a plurality of defined N-dimensional input vectors,
capturing a user input to change at least one of the program parameters,
selecting one of the defined N-dimensional input vectors as a function of the captured user input,
determining a matrix element from the matrix by means of the selected input vector, and
carrying out the treatment program associated with the determined matrix element by means of the controller apparatus.

The embodiments and features described for the proposed system apply correspondingly to the proposed method.

According to a fourth aspect, a computer program product is proposed which initiates the execution of the method as described above on a program-controlled device.

A computer program product, such as a computer program means, can for example be provided or supplied as a storage medium such as a memory card, USB stick, CD-ROM or DVD or also in the form of a file which can be downloaded from a server in a network. This may take place, for example, in a wireless communications network by transferring a corresponding file containing the computer program product or the computer program means.

Further possible implementations of the invention also include combinations of features or embodiments described above or below with regard to exemplary embodiments, even if these combinations are not mentioned explicitly. A person skilled in the art will also add individual aspects as improvements or additions to the relevant basic form of the invention.

Further advantageous embodiments and aspects of the invention form the subject matter of the dependent claims and of the exemplary embodiments of the invention that are described below. The invention is described in greater detail below using preferred embodiments with reference to the accompanying figures.

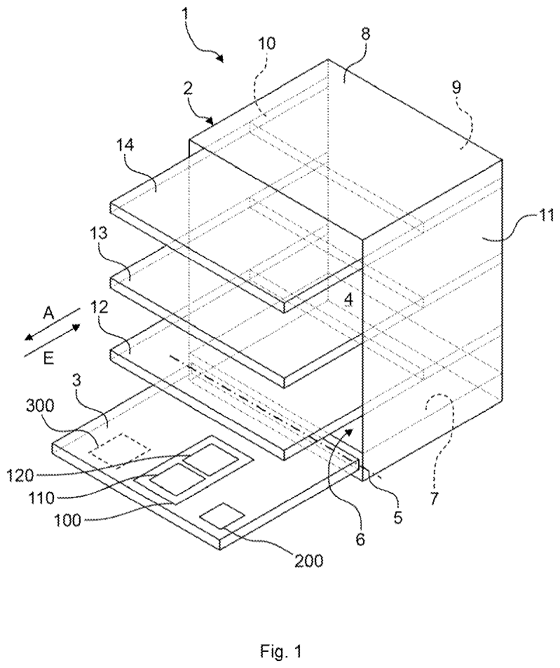

FIG. 1 shows a schematic perspective view of an exemplary embodiment of a system with a household dishwasher;

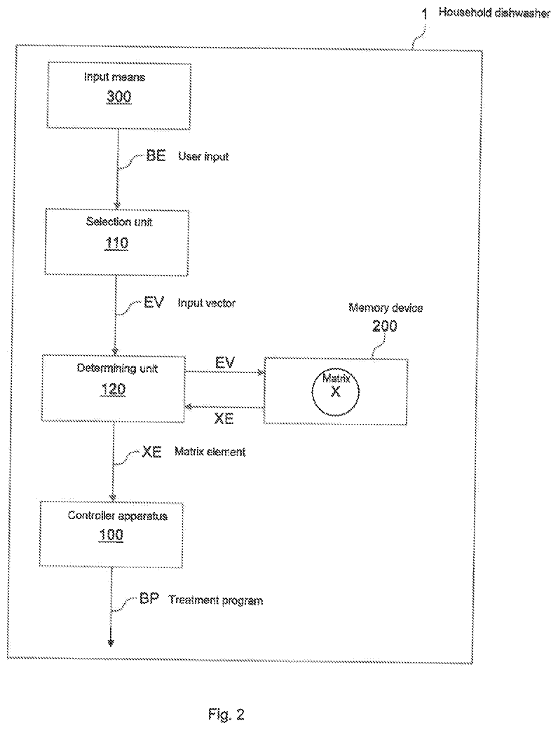

FIG. 2 shows a schematic view of details of the exemplary embodiment of the household dishwasher according to FIG. 1;

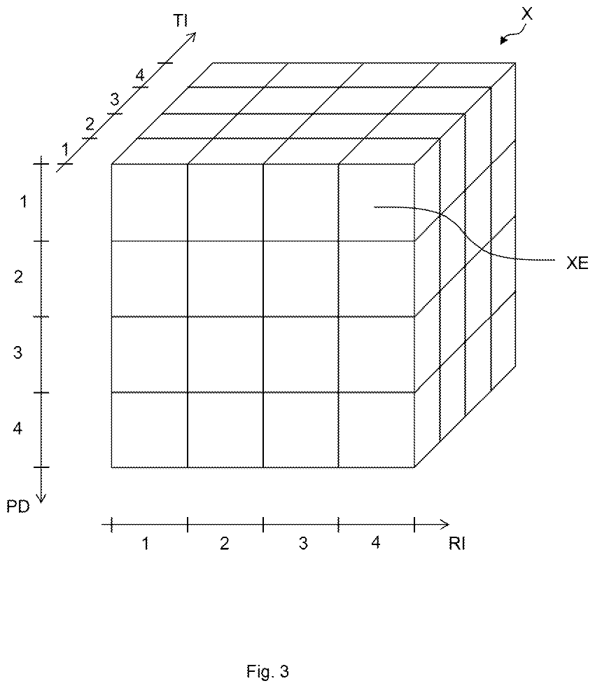

FIG. 3 shows a schematic view of a matrix for storing treatment programs for the household dishwasher according to FIG. 1;

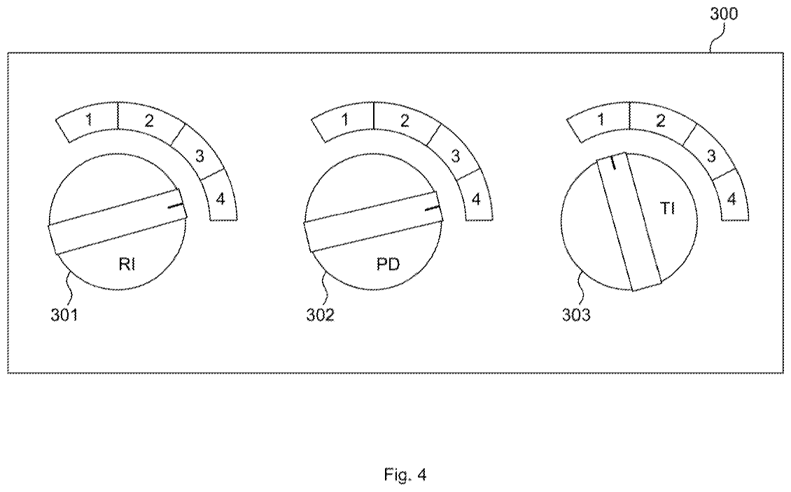

FIG. 4 shows a schematic view of an input means for capturing user inputs of the household dishwasher according to FIG. 1;

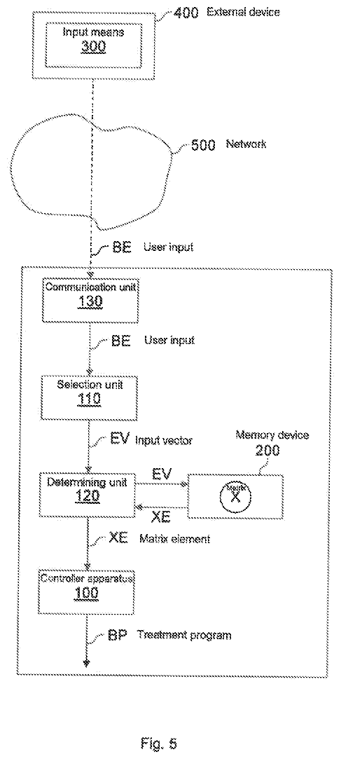

FIG. 5 shows a schematic perspective view of a further exemplary embodiment of a system with a household dishwasher; and

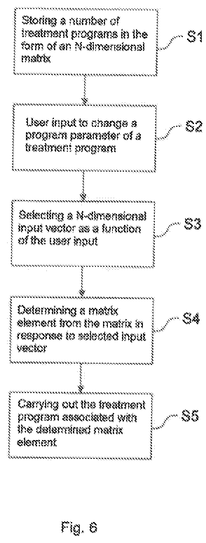

FIG. 6 shows a schematic block diagram of an exemplary embodiment of a method for operating a household dishwasher.

In the figures, elements that are identical or have the same function are provided with the same reference characters unless specified otherwise.

A first exemplary embodiment of the present system with a household dishwasher as an example of a water-bearing household appliance is explained with reference to FIGS. 1 to 4.

In this connection, FIG. 1 shows a schematic perspective view of an exemplary embodiment of a household dishwasher 1 as the system. FIG. 2 shows a schematic view of details of the exemplary embodiment of the household dishwasher according to FIG. 1, FIG. 3 shows a schematic view of a matrix X for storing treatment programs BP for the household dishwasher 1 according to FIG. 1, and FIG. 4 shows a schematic view of an input means 300 for capturing user inputs BE of the household dishwasher 1 according to FIG. 1.

The household dishwasher 1 comprises a dishwasher cavity 2, which can be closed off by a door 3, in particular in a watertight manner. A sealing facility can be provided for this purpose between the door 3 and the dishwasher cavity 2 (not shown). The dishwasher cavity 2 is preferably cuboid in shape. The dishwasher cavity 2 can be arranged in a housing of the household dishwasher 1. The dishwasher cavity 2 and the door 3 can form a washing compartment 4 for washing items to be washed 15.

The door 3 is shown in its opened position in FIG. 1. The door 3 can be closed or opened by pivoting about a pivot axis 5 provided on a lower end of the door 3. A loading opening 6 of the dishwasher cavity 2 can be closed or opened with the aid of the door 3. The dishwasher cavity 2 has a bottom 7, a ceiling 8 arranged opposite the bottom 7, a rear wall 9 arranged opposite the closed door 3 and two side walls 10, 11 arranged opposite one another. The bottom 7, the ceiling 8, the rear wall 9 and the side walls 10, 11 can be manufactured from a stainless-steel sheet, for example. Alternatively, the bottom 7 can be manufactured from a plastic material, for example.

Furthermore, the household dishwasher 1 has at least one receptacle for items to be washed 12, 13, 14. Preferably, a plurality of receptacles for items to be washed 12, 13, 14, for example three, can be provided, wherein the receptacle for items to be washed 12 can be a lower receptacle for items to be washed or a lower basket, the receptacle for items to be washed 13 can be an upper receptacle for items to be washed or an upper basket, and the receptacle for items to be washed 14 can be a cutlery drawer. As additionally shown in FIG. 1, the receptacles for items to be washed 12, 13, 14 are arranged one above the other in the dishwasher cavity 2. Each receptacle for items to be washed 12, 13, 14 is optionally able to be shifted into or out of the dishwasher cavity 2. In particular, each receptacle for items to be washed 12, 13, 14 is able to be inserted into the dishwasher cavity 2 in an insertion direction E and extracted from the dishwasher cavity 2 in an extraction direction A opposite to the insertion direction E.

The household dishwasher 1 also has a controller apparatus 100, which is arranged on the door 3.

The controller apparatus 100 in FIG. 1 is configured to carry out one treatment program BP from a plurality M of treatment programs BP (see FIG. 3). Each of the treatment programs BP is defined by a number of program parameters RI, TI, PD. Examples of program parameters are a cleaning intensity RI, a drying intensity TI and a program duration PD, which the user can set.

The controller apparatus 100 of the household dishwasher 1 in FIG. 1 comprises a selection unit 110 and a determining unit 120. The household dishwasher 1 in FIG. 1 further has a memory device 200 and an input means 300 for capturing user inputs BE of the user of the household dishwasher 1.

The memory device 200 is embodied for example as a RAM memory, as an EPROM memory or as an EEPROM memory. The memory device 200 is configured to store the M treatment programs BP in the form of an N-dimensional matrix X. For the example N=3, FIG. 3 shows an example of a matrix X for storing 64 treatment programs for the household dishwasher 1 according to FIG. 1. The x-axis in FIG. 3 shows the cleaning intensity RI, the y-axis shows the drying intensity TI and the z-axis shows the program duration PD. Therefore, in the example in FIG. 3 there are four possible settings for each of the program parameters RI, TI and PD and thus M=4*4*4=64 different treatment programs BP.

The matrix X in FIG. 3 has 64 matrix elements XE, and one of the 64 treatment programs BP is associated, in particular uniquely, with each of the matrix elements XE. The respective matrix element XE can be determined by means of one of a plurality of defined N-dimensional input vectors EV. As explained above, N is equal to 3 (N=3) for the example in FIGS. 1 to 4.

In this connection, FIG. 2 shows a schematic view of details of the exemplary embodiment of the household dishwasher 1 according to FIG. 1.

The input means 300 is configured to capture a user input BE to change at least one of the program parameters RI, TI, PD. In the example in FIGS. 1 to 4, the input means 300 is part of the household dishwasher 1. With reference to FIG. 5, a further exemplary embodiment will be explained in which the input means 300 is external to the household dishwasher 1.

The selection unit 110 is configured to select one of the defined N-dimensional input vectors EV as a function of the captured user input BE.

Where N=3, the input vector EV is a three-dimensional input vector with three vector components. Each of the vector components of the input vector EV is associated with one of the three dimensions of the matrix X in FIG. 3. For example, the first vector component of the input vector EV is associated with the x-axis of the matrix X, the second vector component of the input vector EV is associated with the y-axis of the matrix X, and the third vector component is associated with the z-axis of the matrix X.

In this example, there are accordingly also 64 different defined input vectors EV which can be selected by means of the selection unit 110.

If for example the input vector EV(RI, PD, TI)=(3, 1, 1) at a particular point in time, this means that the cleaning intensity is set to 3, the program duration is set to 1 and the drying intensity is set to 1. If the user then changes the input vector EV(RI, PD, TI) to (4, 1, 1) by means of a user input BE, then he/she has increased the cleaning intensity RI by 1 (from 3 to 4) by means of his/her user input BE. The input means 300 passes the captured user input BE to the selection unit 110. The selection unit 110 then selects the three-dimensional input vector EV(RI, PD, TI)=(4, 1, 1) and passes it to the determining unit 120.

The determining unit 120 determines a matrix element XE from the matrix X by means of the selected input vector EV(RI, PD, TI)=(4, 1, 1). The determined matrix element XE is provided with the reference character XE in FIG. 3.

The determining unit 120 then passes the determined matrix element XE to the controller apparatus 100 such that the latter is configured to carry out the treatment program BP associated with the determined matrix element XE.

FIG. 4 further shows a schematic view of an input means 300 for capturing the user inputs BE of the household dishwasher 1 according to FIG. 1.

According to the example in FIG. 4, the input means 300 comprises N, where N=3, different rotary dials 301, 302, 303. The user can select the four levels of the cleaning intensity RI with the rotary dial 301. Accordingly, the user can select the four levels of the drying intensity TI with the four possible settings of the rotary dial 302, and select the four levels of the program duration PD with the rotary dial 303. The program duration PD can also be referred to as speed or program speed.

The rotary dials 301, 302, 303 in FIG. 4 represent examples of haptic input devices for changing the program parameters RI, TI, PD. A further example of haptic input devices are slide controls.

Furthermore, it is also possible for the input means 300 to have a touch-sensitive display, which is arranged for example as shown in FIG. 1 on the outside of the door 3. The touch-sensitive display is configured to capture an item of feedback of the user in the form of display inputs as the user's responses to the questions output by the display. For the above-cited example of the adjustment of the program parameter RI, such a question to the user can be: “Do you want to increase the cleaning intensity?” The user is then also provided with two input fields via the touch-sensitive display, one input field with “Yes” and one input field with “No”. In the example shown above, the user has then actuated the input field “Yes” so that the input vector EV(RI, PD, TI)=(4, 1, 1) is selected.

For a user input BE captured by the input means 300 to change one of the program parameters RI, TI, PD outside the defined value range, the controller apparatus 100 determines a measure and triggers or initiates the execution of the determined measure. If for example the value range for the cleaning intensity RI is [1, 2, 3, 4] as in the above example and the user however specifies the value 5 for the cleaning intensity RI via voice input, then his/her user input BE to change the cleaning intensity RI program parameter lies outside the defined value range of [1, 2, 3, 4]. A suitable measure can then be to adjust certain operating parameters, such as for example the washing liquor temperature, in order to improve the cleaning intensity.

FIG. 5 further shows a schematic perspective view of a further exemplary embodiment of a system with a household dishwasher 1. The further exemplary embodiment in FIG. 5 differs from the exemplary embodiment according to FIGS. 1 and 2 in that the input means 300 is arranged externally to the household dishwasher 1. In the example in FIG. 5, the input means 300 is embodied as an app which is installed on an external device 400, for example on a smartphone or on a tablet, and is operated thereon.

The user can then input the user input BE by means of the app 300, and the captured user input BE is transferred by means of the app 300 via a network 500, such as the Internet or an intranet, to the household dishwasher 1.

For communication with the external device 400, the household dishwasher 1 has a communication unit 130. In the example in FIG. 5, the communication unit 130 receives the captured user input BE and forwards the received user input BE to the selection unit 110.

The app 300 can also be embodied for example as a voice dialog system on the external device 400. The voice dialog system is configured in particular to capture an item of feedback of the user in the form of voice inputs as the user's responses to the voice outputs generated as questions by the voice dialog system. For example, the voice dialog system can ask the user whether he/she would like a shortened program duration. The user can then reply to the voice dialog system by means of a voice input that he/she would like a shortened program duration, which results in an incrementation of the vector component for the program duration PD in the input vector EV.

The further functionalities of the determining unit 120, the memory device 200 and the controller apparatus 100 are as shown in the example in FIG. 2.

FIG. 6 shows a schematic block diagram of a method for operating a household dishwasher 1, such as for example the household dishwasher 1 in FIG. 1 or FIG. 5. The method in FIG. 6 comprises the steps S1 to S5:

In step S1, a number M of treatment programs BP is stored in the form of an N-dimensional matrix X in a memory device 200. Here, one of the M treatment programs BP is associated in each case with a matrix element XE of the matrix X. The respective matrix element XE can be determined by means of a defined N-dimensional input vector EV.

In step S2, a user input BE to change at least one of the program parameters RI, TI, PD is captured.

In step S3, one of the defined N-dimensional input vectors EV is selected as a function of the captured user input BE.

In step S4, one matrix element XE from the matrix X is determined by means of the selected input vector EV.

In step S5, the treatment program BP associated with the determined matrix element ME is carried out by means of the controller apparatus 100.

Although the present invention has been described with reference to exemplary embodiments, it can be modified in numerous different ways.

### REFERENCE CHARACTERS USED

1 Household dishwasher

2 Dishwasher cavity

3 Door

4 Washing compartment

5 Pivot axis

6 Loading opening

7 Bottom

8 Ceiling

9 Rear wall

10 Side wall

11 Side wall

12 Receptacle for items to be washed

13 Receptacle for items to be washed

14 Receptacle for items to be washed

100 Controller apparatus

110 Selection unit

120 Determining unit

130 Communication unit

200 Memory device

300 Input means

301 Rotary control

302 Rotary control

303 Rotary control

400 External device

500 Network

A Extraction direction

BE User input

BP Treatment program

E Insertion direction

EV Input vector

PD Program duration

RI Cleaning intensity

TE Drying intensity

S1 Method step

S2 Method step

S3 Method step

S4 Method step

S5 Method step

X Matrix

XE Matrix element

1-15. (canceled)

16. A system, comprising a water-bearing household appliance, said water bearing household appliance comprising
a controller apparatus configured to carry out a treatment program selected from a plurality of treatment programs, with each of the treatment programs being defined by a number of program parameters;
a memory device configured to store the plurality of treatment programs in the form of a N-dimensional matrix having matrix elements, with the plurality of treatment programs being associated with the matrix elements of the matrix in one-to-one correspondence, each said matrix element being determinable by a respective one of a plurality of defined N-dimensional input vectors;
an input configured to capture a user input to change at least one of the program parameters;
a selection unit configured to select one of the defined N-dimensional input vectors as a function of the captured user input; and
a determining unit configured to determine one of the matrix elements from the matrix as a function of the selected input vector,
wherein the controller apparatus is configured to carry out the treatment program associated with the determined matrix element.

17. The system of claim 16, wherein the water-bearing household appliance is a dishwasher.

18. The system of claim 16, wherein the program parameters which are adjustable by the user comprise a cleaning intensity, a drying intensity and/or a program duration.

19. The system of claim 16, wherein the number of adjustable program parameters is N, wherein the N-dimensional input vector has N vector components, with a respective one of the vector components of the input vector being associated with one of the N-dimensions of the matrix.

20. The system of claim 16, wherein the matrix is a three-dimensional matrix defined by discrete values x, y, z, with a number of treatment programs corresponding to a product of x, y and z, and wherein N=3.

21. The system of claim 20, wherein x defines a value range of a first vector component of the input vector, y defines a value range of a second vector component of the input vector, and z defines a value range of a third vector component of the input vector.

22. The system of claim 21, wherein the controller apparatus is configured, in response to a user input captured by the input to change one of the program parameters outside the defined value range, to determine a measure and to trigger execution of a determined measure.

23. The system of claim 16, wherein the input has N haptic input devices, each of the N haptic input devices being associated with one of the N adjustable program parameters.

24. The system of claim 23, wherein the respective haptic input device has a rotary dial or a slide control.

25. The system of claim 16, wherein the input is configured to capture an item of feedback of the user after completion of one of the treatment programs and to change at least one of the program parameters as a function of the captured feedback.

26. The system of claim 25, wherein the input includes a voice dialog system, which is configured to capture the user's feedback in the form of voice inputs as the user's responses to voice outputs generated as questions by the voice dialog system.

27. The system of claim 25, wherein the input includes a touch-sensitive display, which is configured to capture the user's feedback in the form of display inputs as the user's responses to questions output by the display.

28. The system of claim 16, wherein the input is integrated in the household appliance.

29. The system of claim 16, wherein the input is embodied as an app which can be installed on an external device.

30. A method for operating a water-bearing household appliance, in particular dishwasher, said method comprising:
storing in a memory device in the form of an N-dimensional matrix a plurality of treatment programs, each defined by a number of program parameters, with the plurality of treatment programs being associated with matrix elements of the matrix in one-to-one correspondence, each said matrix element being determinable by a respective one of a plurality of defined N-dimensional input vectors;
capturing a user input to change at least one of the program parameters;
selecting one of the defined N-dimensional input vectors as a function of the captured user input;
determining a matrix element from the matrix by means of the selected input vector; and
carrying out by a controller apparatus the treatment program associated with the determined matrix element.

31. A computer program product for operating a water-bearing household appliance, comprising a computer program embodied in a non-transitory computer readable medium, wherein the computer program, when loaded into a program-controlled device and executed by the program-controlled device, causes the program-controlled device processor to perform the method of claim 30:
